(19) United States
(12) Patent Application Publication
(10) Pub. No.: US 2003/0161151 A1
(43) Pub. Date: Aug. 28, 2003

(54) Multi-color pipe-type lamp

(76) Inventor: Chun-Ming Liu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,277

(22) Filed: Feb. 26, 2002

(51) Int. Cl. F21V 21/00

(52) U.S. Cl. 362/249

(57) ABSTRACT

The present invention relates to a multi-color pipe-type lamp, which includes an inner tube and an outer transparent tube. The characteristic of this invention is to provide several middle tubes between the inner tube and the outer tube. The middle tube can be the same color of different color as desired and can be arranged in order or in disorder. As the lamp is lightened, it obtains multi-color due to the colorful middle tube that increases the decorative effect. Various decorations can be obtained according the invention.

### BACKGROUND OF THE INVENTION

A normal pipe-type lamp is always mono-color, which is the color of the bulb. In order to have colorful decorative effect of the pipe-type lamp, it is known to spray paint over an outer tube of the lamp. This method is inconvenient and the paint is usually not well-distributed. Moreover, the surface of the outer tube will be rough because of the sprayed paint, which is also possibly dropped.

Accordingly, the primary object of the invention is to provide a multi-color pipe-type lamp, which uses several middle color tubes to be assembled between the outer tube and inner tube for providing a well-utilized product. Now the features and advantages of the present invention will be described in detail with reference to the accompanying drawings.

### BRIEF DESCRIPTION OF ACCOMPANYING DRAWINGS

FIG. 1 is an exploded perspective view showing a multi-color pipe-type lamp according to the present invention.

FIG. 2 is an assembled perspective view showing a multi-color pipe-type lamp according to the present invention.

### DETAILED DESCRIPTION OF PREFERRED EMBODIMENTS

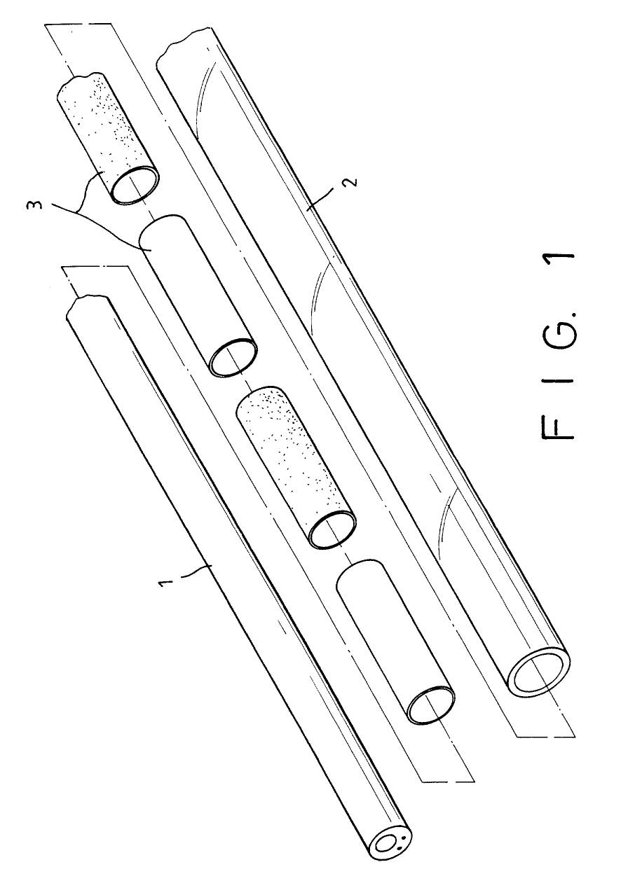

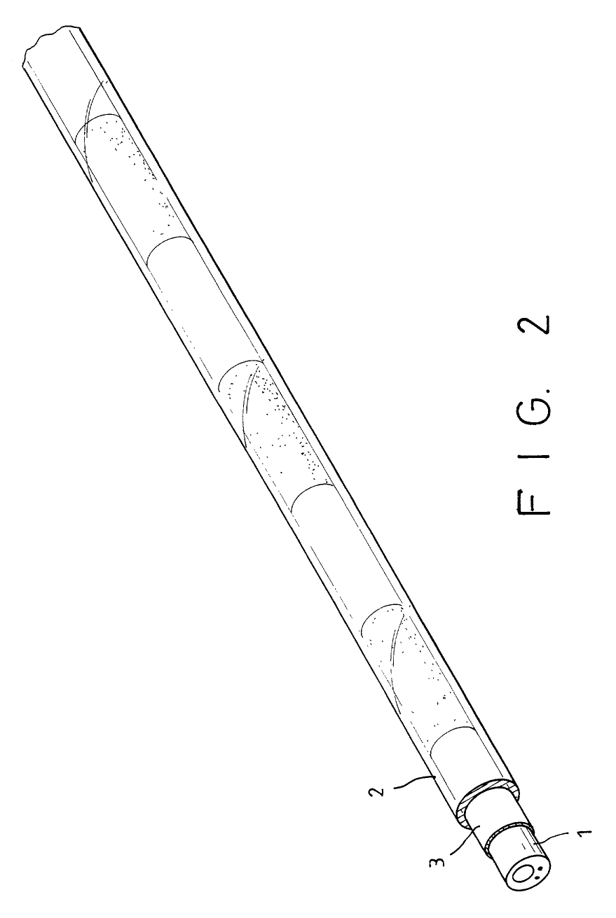

Please refer to FIGS. 1 and 2, the present invention includes a pipe-type lamp having an inner tube (1) and an outer tube (2). The characteristic of the invention is to provide several middle tubes (3), which could be the same color or different color. In use, it is possible for a user to select the middle tube (3) having a desired color for positioning between the inner tube (1) and the transparent outer tube (2).

Since the middle tube (3) is covered by the outer tube (2), it can be found that the lamp will have a smooth surface based on the outer tube (2). Dropped paint will not be happened in deed. Furthermore, it is possible to choose any different color of middle tube (2) in different arrangement to obtain a various decorative effect of the pipe-type lamp. The length of the middle tube (3) is also changeable for more variation.

Accordingly, the invented assembly of the present invention obviously obtains utility and improvement. It should be allowed for patent and is applied.

What is claimed is:

1. A multi-color pipe-type lamp including an inner tube and an outer transparent tube, and the characteristic is to provide several middle tubes, which can be the same color or different color in order or disorder arrangement between the inner tube and the outer tube for providing multi-color outlook.

2. The multi-color pipe-type lamp as claimed in claim 1, wherein the length of the middle tube can be the same or different.
